(19) United States
(12) Patent Application Publication
(10) Pub. No.: US 2009/0250014 A1
(43) Pub. Date: Oct. 8, 2009

(54) Cat litter box

(76) Inventor: Chris Juan, Banciao City (TW)

Correspondence Address: BACON & THOMAS, PLLC, 625 SLATERS LANE, FOURTH FLOOR, ALEXANDRIA, VA, 22314-1176, US

(21) Appl. No.: 12/078,824

(22) Filed: Apr. 7, 2008

(51) Int. Cl. A01K 29/00; A01K 1/00

(52) U.S. Cl. 119/482; 119/165

(57) ABSTRACT

A cat litter box has a housing and a tray. The housing has a bottom segment and a top segment. The bottom segment has a lower chamber, a front open end and a slope. The slope is formed in the lower chamber. The top segment is formed on the bottom segment and has an upright passage and a front entrance. The upright passage is above the slope. The tray is mounted in the lower chamber through the front open end. The cat litter box is configured to provide litter-cleaning procedures to cats so that a cat may drain in the cat litter box without bring inadvertently out litter particles to pollute everywhere to result in frequently cleaning of the indoor environment.

### BACKGROUND OF THE INVENTION

1. Field of the Invention

The present invention relates to a cat litter box, and more particularly to a cat litter house that prevents litter therein from sputtering out of the cat litter box and from being brought out by cats.

2. Description of Related Art

A conventional cat litter tray receives litter and allows a cat to drain in the cat litter tray. After draining, cat in the cat litter tray would poke litter to cover excrements with its palms, which causes litter to sputter out of the cat litter tray inadvertently. Furthermore, a little litter stuck on the cat's palms and is brought inadvertently out of the cat litter tray by the cat to stain everywhere, which causes the cat's host to spend much time frequently cleaning the indoor environment.

To overcome the shortcomings, the present invention provides a cat litter box to mitigate or obviate the aforementioned problems.

### SUMMARY OF THE INVENTION

The main objective of the invention is to provide a cat litter house that prevents litter therein from sputtering out of the cat litter box and from being brought out by cats.

A cat litter box in accordance with the present invention comprises a housing and a tray. The housing has a bottom segment and a top segment. The bottom segment has a lower chamber, a front open end and a slope. The slope is formed in the lower chamber. The top segment is formed on the bottom segment and has an upright passage and a front entrance. The upright passage is above the slope. The tray is mounted in the lower chamber through the front open end. The cat litter box is configured to provide litter-cleaning procedures to cats so that a cat may drain in the cat litter box without bring inadvertently out litter particles to pollute everywhere to result in frequently cleaning of the indoor environment.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a cat litter box in accordance with the present invention;

FIG. 3 is a perspective view of the cat litter box in FIG. 1 with phantom lines showing the interior structures thereof; and

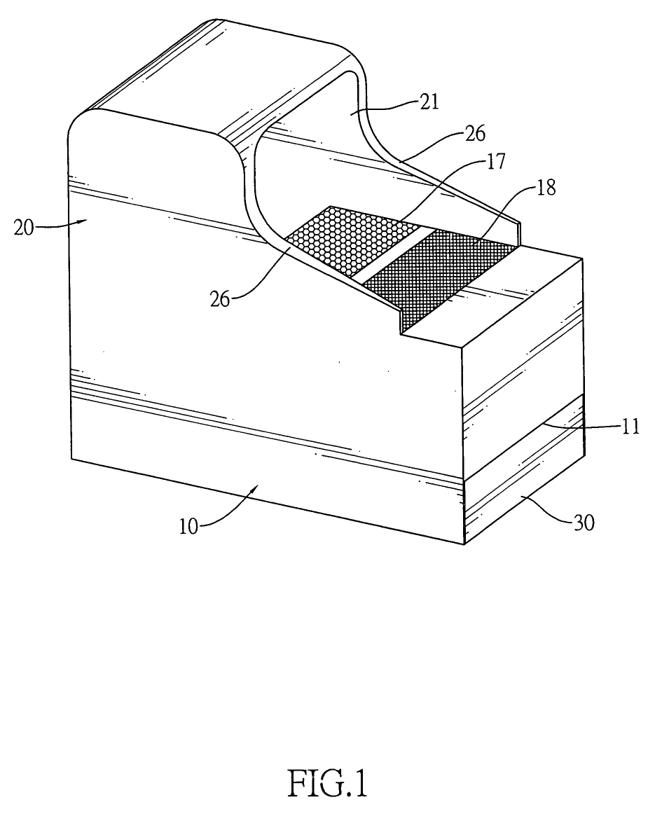

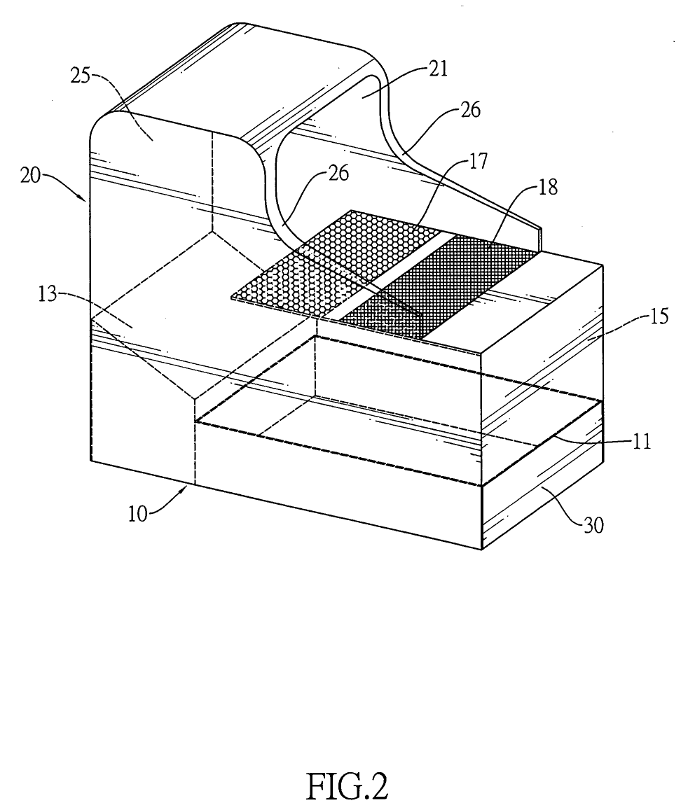

FIG. 2 is an operational perspective view of the cat litter box in FIG. 1.

### DETAILED DESCRIPTION OF THE PREFERRED EMBODIMENT

With reference to FIGS. 1 and 2, a cat litter box in accordance with the present invention comprises a housing and a tray (30).

The housing has a bottom segment (10) and a top segment (20).

The bottom segment (10) is longitudinal and has a front open end (11), a rear end, a top, a bottom, a lower chamber (15) and a slope (13) and may further have a coarse grid (17) and a fine grid (18). The lower chamber (15) is defined in the bottom segment (10), communicates with the front open end (11) and allows a cat to enter the lower chamber (11). The slope (13) is formed in the lower chamber (15) adjacent to the rear end, is inclined relative to the bottom of the bottom segment (10) and has an upper rear end and a lower front end. The upper rear end is adjacent to the rear end of the bottom segment (10). The slope (13) allows the cat to move into the lower chamber (11) or move out of the housing through the slope (13). When the cat moves away from the slope (13), litter on the slope (13) would fall into the lower chamber (11) due to gravity. The coarse grid (17) is mounted on the top of the bottom segment (10) near the rear end, communicates with the lower chamber (11) and has multiple meshes. The fine grid (18) is mounted on the top of the bottom segment in front of the coarse grid (17) and has multiple meshes. A size of each mesh of the fine grid (18) is smaller than that of each mesh of the coarse grid (17). When the cat moves out of the housing and sequentially passes through the coarse grid (17) and the fine grid (18), larger litter particles on cat's palms fall easily through the coarse grid (17) into the lower chamber (11) and remaining smaller litter particles on the palms fall easily through the fine grid (17) into the lower chamber (11).

The top segment (20) is formed on the top of the bottom segment adjacent to the rear end, communicates with the bottom segment (10) and has an upright passage (25) and a front entrance (21) and may further have two rails (26). The upright passage (25) is defined in the top segment (20) above the slope (13) and communicates with the lower chamber (15). The front entrance (21) communicates with the upright passage (25), has two opposite side edges and may be located above the coarse grid (17). The rails (26) are formed on and protrude respectively forward from the side edges of the front entrance (21) to prevent the cat from inadvertently falling out of the housing.

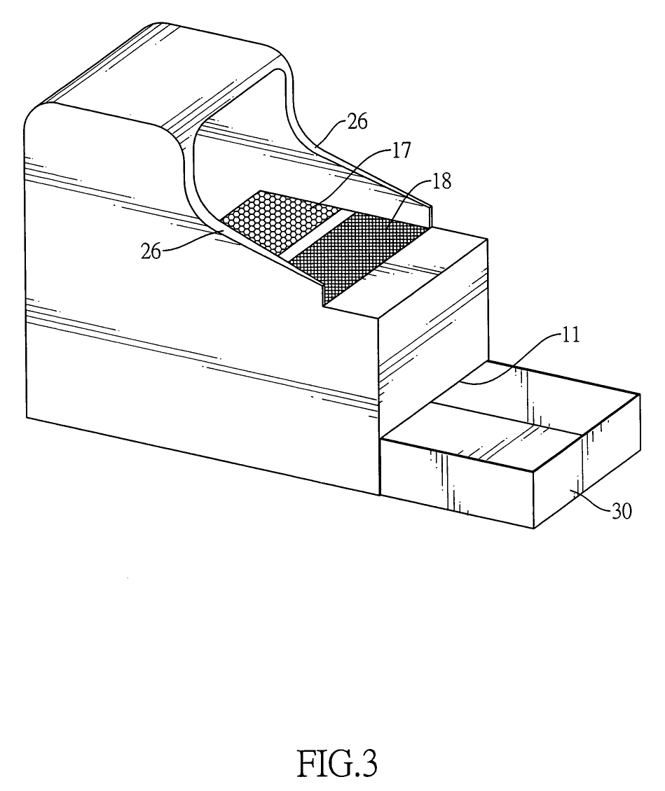

With further reference to FIG. 3, the tray (30) may be a drawer, is mounted slidably and detachably the lower chamber (15) through the front open end (11) of the bottom segment (10) of the housing, selectively closes the front open end (11), is adjacent to the lower front end of the slope (30) and has a cavity (31) defined in the tray (30) and receiving litter. The tray (30) may also collect litter particles falling from the coarse and fine grids (17,18). The detachable tray (30) facilitates the replacement of the dirty used litter in the tray (30).

When draining, the cat entries the housing through the front entrance (21), jumps to the slope (13) and then moves in the tray (30) inside the lower chamber (11). The tray (30) inside the lower chamber (11) prevents the litter poked by the cat from inadvertently sputtering out of the housing, which is a first litter-cleaning procedure to the cat.

After draining, the cat jumps to the slope (13), jumps to the top of bottom segment (10) and then passes out of the front entrance (21). When the cat moves to the slope (13), the litter particles falling on the slope (30) would slide down into the tray (30), which is a second litter-cleaning procedure to the cat. When the cat jumps from the slope (13) to the top of the bottom segment (10), most of litter particles on the cat are shaken off and fall in the tray (30), which is a third litter-cleaning procedure to the cat. When the cat passes through the coarse grid (17) and the fine grid (18), litter particles of different sizes on the palms or other portions of the cat falling through the coarse and fine grids (17, 18), which are fourth and fifth litter-cleaning procedures to the cat.

The cat litter box is configured to provide five litter-cleaning procedures to cats as described above so that a cat may drain in the cat litter box without bring inadvertently out litter particles to pollute everywhere to result in frequently cleaning of the indoor environment.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A cat litter box comprising:
a housing having
a bottom segment having
an front open end;
a rear end;
a top;
a bottom;
a lower chamber defined in the bottom segment and communicating with the front open end;
a slope formed in the lower chamber adjacent to the rear end, inclined relative to the bottom of the bottom segment and having
an upper rear end being adjacent to the rear end of the bottom segment; and
a lower front end; and
a top segment formed on the top of the bottom segment adjacent to the rear end, communicating with the bottom segment and having
an upright passage defined in the top segment above the slope and communicating with the lower chamber; and
a front entrance communicating with the upright passage and having two opposite side edges; and
a tray mounted in the lower chamber through the front open end of the bottom segment of the housing, selectively closing the front open end, being adjacent to the lower front end of the slope and having a cavity defined in the tray.

2. The cat litter box as claimed in claim 1, wherein the bottom segment of the housing further has
a coarse grid mounted on the top of the bottom segment near the rear end, communicates with the lower chamber and having multiple meshes; and
a fine grid mounted on the top of the bottom segment in front of the coarse grid and having multiple meshes.

3. The cat litter box as claimed in claim 2, wherein a size of each mesh of the fine grid is smaller than that of each mesh of the coarse grid.

4. The cat litter box as claimed in claim 3, wherein the top segment further has two rails formed on and protruding respectively forward from the side edges of the front entrance.

5. The cat litter box as claimed in claim 4, wherein the tray is a drawer and is mounted slidably and detachably in the lower chamber.
